(19) United States
(12) Patent Application Publication
(10) Pub. No.: US 2026/0029574 A1
(43) Pub. Date: Jan. 29, 2026

(54) PHOTONIC INTEGRATED CIRCUITS WITH DOPED FUNCTIONAL STRUCTURES

(71) Applicant: Santec Holdings Corporation, Komaki (JP)

(72) Inventors: Alan She, Santa Clara, CA (US); Changho Chong, Los Altos, CA (US)

(73) Assignee: Santec Holdings Corporation, Komaki (JP)

(21) Appl. No.: 18/783,059

(22) Filed: Jul. 24, 2024

(51) Int. Cl. G02B 6/12; G02B 6/122; G02B 6/13

(52) U.S. Cl. CPC G02B 6/12004; G02B 6/1228; G02B 6/13

(57) ABSTRACT

A photonic integrated circuit includes a first waveguide, a second waveguide optically connected with the first waveguide, and a functional structure disposed adjacent to the second waveguide and optically connected with the second waveguide. The functional structure is doped with a dopant that allows the functional structure to have a functionality and includes a surface to receive a signal configured to activate the functionality.

### BACKGROUND

The following description is provided to assist the understanding of the reader. None of the information provided or references cited is admitted to be prior art.

Photonic integrated circuits (PICs) have been utilized in modern optical communication and signal processing systems. The PICs include various interconnected optical and/or photonic components. For example, an Erbium-doped waveguide amplifier (EDWA) can include an Erbium-doped waveguide (EDWG) to amplify light in the PIC.

### SUMMARY

The techniques disclosed herein provide PICs with doped functional structures and methods of manufacturing the same.

One aspect of the present disclosure is directed to a photonic integrated circuit (PIC). The PIC includes a first waveguide, a second waveguide optically connected with the first waveguide, and a functional structure disposed adjacent to the second waveguide and optically connected with the second waveguide, the functional structure doped with a dopant that allows the functional structure to have a functionality, the functional structure including a surface to receive a signal configured to activate the functionality.

In some embodiments, a first cross sectional area of the first waveguide is larger than a second cross sectional area of the second waveguide, and the PIC includes a tapered waveguide portion optically connecting the first waveguide with the second waveguide.

In some embodiments, the surface is configured to receive the signal from one of: a top portion of the functional structure, a bottom portion of the functional structure, a side portion of the functional structure, or an inside portion of the functional structure. In some embodiments, the functional structure is configured to be driven by the signal to provide the functionality, the signal including one of: an optical signal configured to optically activate the functional structure to provide the functionality, an electrical signal configured to electrically activate the functional structure to provide the functionality, a thermal signal configured to thermally activate the functional structure to provide the functionality, a magnetic signal configured to magnetically activate the functional structure to provide the functionality, an acoustic signal configured to acoustically activate the functional structure to provide the functionality, a chemical signal configured to chemically activate the functional structure to provide the functionality, or a mechanical signal configured to mechanically activate the functional structure to provide the functionality.

In some embodiments, the PIC includes a second functional structure optically connected with the first waveguide, the second functional structure having a second functionality. In some embodiments, the PIC includes an optical component optically connected to the first functional structure or the second functional structure, the optical component including one of: a splitter, an optical combiner, an optical coupler, a grating, a polarization rotator, a detector, or a light source.

In some embodiments, the functionality includes in response to receiving light, i) amplifying the light or ii) tuning a characteristic of the light, the characteristic including one of an amplitude, a phase, a wavelength, a spectral property, or a dispersion property of the light. In some embodiments, the functional structure includes a non-linear material.

Another aspect of the present disclosure is directed to a device. The device includes a first functional structure having a first functionality, a second functional structure having a second functionality, and a waveguide vertically disposed relative to the first functional structure and the second functional structure, the waveguide optically connecting the first functional structure with the second functional structure. One of the first functional structure or the second functional structure is doped with a dopant that allows the one of the first functional structure or the second functional structure to have a corresponding functionality.

In some embodiments, each of the first functionality and the second functionality includes, in response to receiving light, to i) amplifying the light or ii) tuning a characteristic of the light, the characteristic including one of an amplitude, a phase, a wavelength, a spectral property, or a dispersion property of the light. In some embodiments, the first functionality is different from the second functionality. In some embodiments, one of the first functional structure or the second functional structure is configured to be driven by a signal to provide the corresponding functionality, the signal including one of: an optical signal configured to optically activate the functional structure to provide the functionality, an electrical signal configured to electrically activate the functional structure to provide the functionality, a thermal signal configured to thermally activate the functional structure to provide the functionality, a magnetic signal configured to magnetically activate the functional structure to provide the functionality, an acoustic signal configured to acoustically activate the functional structure to provide the functionality, a chemical signal configured to chemically activate the functional structure to provide the functionality, or a mechanical signal configured to mechanically activate the functional structure to provide the functionality.

In some embodiments, the one of the first functional structure or the second functional structure includes one of: a surface to receive an optical signal, an electrode to be electrically driven by an electrical signal provided through the electrode, a heating element configured to change a temperature of the one of the first functional structure or the second functional structure, a magnetic material configured to change a polarization of a light in response to receiving a magnetic signal, a fluidic channel to provide a chemical agent that causes a chemical reaction with the one of the first functional structure or the second functional structure, or a microelectromechanical system (MEMS) component configured to provide a mechanical signal to deform a structure of the one of the first functional structure or the second functional structure.

In some embodiments, the device includes a third functional structure having a third functionality, the third functional structure optically connected with the first functional structure in series or in parallel. In some embodiments, the device includes a third functional structure having a third functionality, the third functional structure vertically disposed relative to the first functional structure.

Another aspect of the present disclosure is directed to a method of manufacturing a photonic integrated circuit (PIC). The method includes providing a substrate, forming a first waveguide and a second waveguide above the substrate, and forming a functional structure adjacent to the second waveguide and optically connected with the second waveguide, the functional structure doped with a dopant that allows the functional structure to have a functionality, by one of: depositing a functional material on the second waveguide and implanting the dopant into the functional material, or transferring the functional structure doped with the dopant onto the second waveguide, wherein a surface of the functional structure is configured to receive a signal configured to activate the functionality.

In some embodiments, the functionality includes, in response to receiving light, i) amplifying the light or ii) tuning a characteristic of the light, the characteristic including one of an amplitude, a phase, a wavelength, a spectral property, or a dispersion property of the light, and wherein the dopant includes one of erbium, thulium, or ytterbium.

In some embodiments, the method includes forming a second functional structure optically connected with the first waveguide, the second functional structure having a second functionality. In some embodiments, the method includes optically connecting a third functional structure with the first functional structure in series or in parallel, the third functional structure having a third functionality. In some embodiments, the forming of the functional structure is performed by transferring the functional structure doped with the dopant onto the second waveguide, and includes: bonding a surface of the functional structure with a surface of the second waveguide, and annealing the bonded surfaces.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 depicts a cross sectional view of a portion of an example photonic integrated circuit (PIC), in accordance with various embodiments.

FIG. 2A depicts a top view of a portion of an example PIC, in accordance with various embodiments.

FIG. 2B and FIG. 2C depict cross sectional views of the PIC shown in FIG. 2A, in accordance with various embodiments.

FIG. 2D and FIG. 2E depict example optical mode profiles associated with the PIC shown in FIG. 2B and FIG. 2C, respectively.

FIG. 3A depicts a top view of a portion of an example PIC, in accordance with various embodiments.

FIG. 3B depicts a top view of a portion of an example PIC, in accordance with various embodiments.

FIG. 4A, FIG. 4B, and FIG. 4C depict cross sectional views of example implementations of a PIC, in accordance with various embodiments.

FIG. 5A, FIG. 5B, FIG. 5C, FIG. 5D, and FIG. 5E depict cross sectional views of example implementations of a PIC, in accordance with various embodiments.

FIG. 6A depicts a top view of a portion of an example PIC, in accordance with various embodiments.

FIG. 6B depicts a top view of a portion of an example PIC, in accordance with various embodiments.

FIG. 7 depicts a flow chart of an example method of manufacturing an example PIC, in accordance with various embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

In general, PICs are limited in functionality, primarily due to constraints in waveguide design and integration with functional materials. Implanting dopants into the waveguide core poses challenges as the process can damage or deform the waveguide structure due to the high energy and temperatures involved. This damage exacerbates propagation loss and is incompatible with delicate processes like CMOS fabrication, etc. For instance, in EDWAs, the propagation loss is a significant issue due to the extended propagation lengths for various applications. Moreover, introducing new materials into established production lines risks contamination and disruption of the manufacturing processes.

It should be appreciated, therefore, that a PIC that enables the integration of various functional materials and enhanced optical confinement, while also mitigating the contamination risks, is of interest. Techniques disclosed herein provide a functional structure optically connected with a waveguide. As used herein, the term “functional structure” refers to a structure, a layer, a thin film, etc., that includes a material or the material itself, wherein the material possesses optical or optoelectronic properties (e.g., amplification, electro-optical tuning, modulation, etc.) for a particular application associated with the optical or optoelectronic properties, and the optical or optoelectronic properties can be activated by a signal (e.g., an optical signal, an electrical signal, a thermal signal, a magnetic signal, an acoustic signal, a chemical signal, a mechanical signal, etc.). According to this disclosure, the functional structure is doped with a dopant that imparts and/or enhance the functionalities, such as, e.g., amplification, electro-optical tuning, modulation, which can be activated by an activation signal (e.g., an optical signal, an electrical signal, a thermal signal, a magnetic signal, an acoustic signal, a chemical signal, a mechanical signal, etc.). For example, in response to receiving light to be processed, the functional structure can amplify the light and deliver an amplified light through the optically connected waveguide.

The functional structure can be formed independently from the waveguide. This independence allows for modular manufacturing, opening up the possibilities for mix-and-match configurations. This modularity can simplify the manufacturing process by decoupling the fabrication of the waveguides from the fabrication of the functional structures. As a result, complex and/or chemically aggressive processes (e.g., patterning, ion implantation, doping, etc.) on the waveguide can be eliminated. The functional structure can be integrated into separate layers, which can then be combined with the waveguide in a modular fashion, thereby reducing the risk of defects while improving the overall yield.

Furthermore, the techniques disclosed herein allow for greater flexibility in design, enabling the customization of PICs for various applications by simply selecting and combining different pre-fabricated functional structures and waveguides. This mix-and-match capability can enable faster prototyping and production cycles, as well as more cost-effective manufacturing. Additionally, this modular approach can alleviate the risk of contaminating stable production lines when new materials are introduced.

Furthermore, the doped functional structures allow for various configurations, enhancing design and manufacturing flexibility. The functional structures can be driven to activate the functionality in various manners (e.g., optically, electrically, electro-optically, thermally, magnetically, acoustically, chemically, mechanically, etc.), enabling the integration of multiple functions. In some embodiments, the functional structures can be configured to provide both amplification as well as modulation (e.g., electro-optical tuning, thermal modulation, etc.) of light, opening up the possibilities for utilizing the PICs in different applications (e.g., transceivers, amplifiers, tunable lasers, wavelength converters, optical modulators, photodetectors, quantum photonic devices, high-power devices, multifunctional PICs, etc.), while allowing for the use of different modulation techniques (e.g., optical, electrical, electro-optical, thermal, magnetic, acoustical, chemical, mechanical, etc.). This flexibility in activating configurations offers additional benefits and applications. In addition, the integration of material capabilities for both amplification and modulation within a same layer/structure can be achieved. By combining the waveguides and functional structures with different functions, the PICs can be configured to perform various, complex functionalities (e.g., amplification, lasing, tuning, modulation, combination thereof, etc.). Furthermore, the functional structure and the connected waveguide can be designed to increase the optical mode areas, thereby capturing more of the étendue of the pump radiation pattern and thus improving the performance of the PICs.

Reference is now made to the figures. Although the figures and description below can show and describe structures herein as having a particular shape, it should be understood that such shapes are merely illustrative and should not be considered limiting. For example, the techniques described herein can be implemented in any shape or geometry for any material or layer to achieve desired results. It should be understood that like reference numerals can refer to like elements throughout, repetitive descriptions of which can be omitted. It should be also noted that in the drawings, the dimensions of the features are not intended to be to true scale and can be exaggerated for the sake of allowing greater understanding.

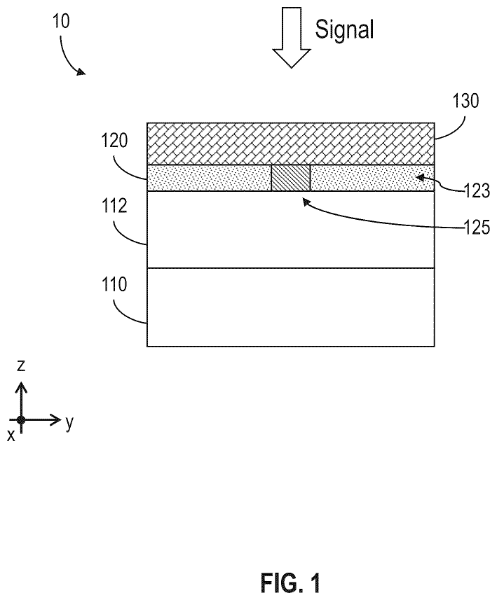

FIG. 1 depicts a cross sectional view of a portion of an example photonic integrated circuit (PIC) 10, in accordance with various embodiments. In some embodiments, the portion of the PIC 10 shown in FIG. 1 is a multilayer structure configured to process (e.g., amplify, modulate, etc.). The PIC 10 includes a substrate 110, a base structure 112, a fill structure 123 of a waveguide layer 120, a waveguide 125 of the waveguide layer 120, and a functional structure 130. The PIC 10 shown in FIG. 1 is simplified for illustrative purposes, and thus, can be implemented as any of various other configurations while remaining within the scope of the present disclosure. In some embodiments, the PIC 10 can include more, fewer, or different components than shown in FIG. 1.

In some embodiments, the substrate 110 is a wafer or any structure on which the base structure 112, the fill structure 123, the waveguide 125, the functional structure 130, etc., can be formed. In some embodiments, the substrate 110 is a semiconductor substrate (e.g., a bulk semiconductor, a semiconductor-on-insulator (SOI) substrate, or the like). The substrate 110 can be a semiconductor wafer (e.g., silicon, silicon oxide, aluminum oxide, etc.). In some embodiments, the substrate 110 is a multi-layered or gradient substrate. In some embodiments, the base structure 112 is part of the substrate 110 (e.g., SOI substrates). In some embodiments, the base structure 112 is or includes an oxide layer (e.g., silicon oxide, etc.).

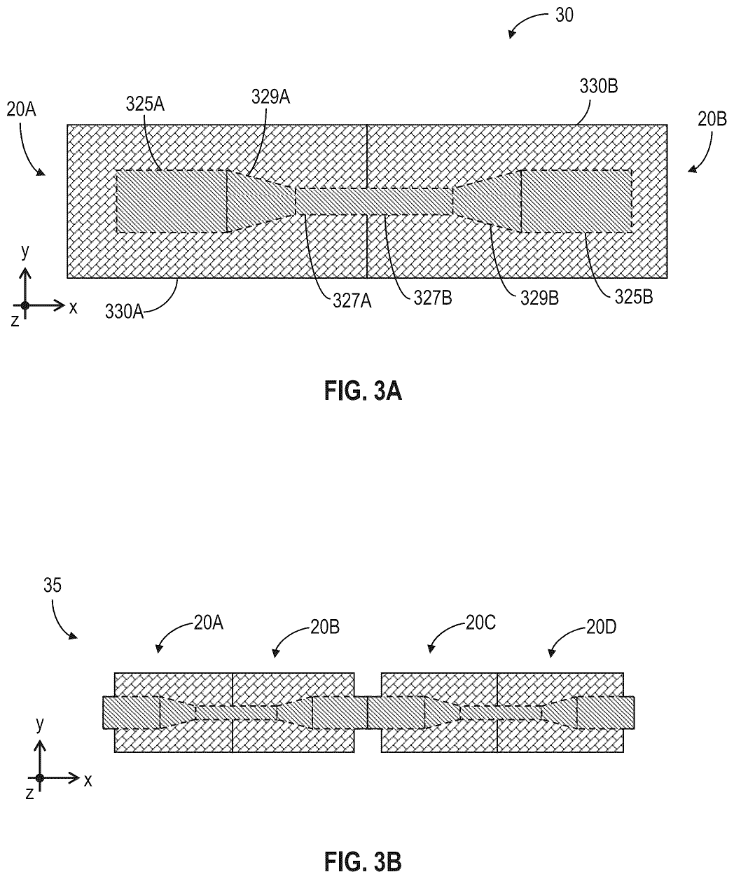

The waveguide layer 120 of the PIC 10 can include the fill structure 123 and the waveguide 125. In some embodiments, the waveguide 125 is formed of a material, including but not limited to, silicon, silicon nitride, aluminum oxide, etc. In some embodiments, the waveguide 125 is formed of any material whose refractive index is higher than that of the fill structure 123. In some embodiments, the waveguide 125 is capped with a material having a refractive index lower than that of the waveguide 125. In some embodiments, the waveguide 125 is vertically disposed relative to the functional structure 130, as shown in FIG. 1. The waveguide 125 can be optically connected with the functional structure 130. In some embodiments, the waveguide 125 is optically connected with the functional structure 130 at a first end, and optically connected with an optical component at a second end. The optical component can be, in some embodiments, a second functional structure (e.g., as shown in FIG. 3A), a light source, a detector, a reflector, an optical filter, a grating, a splitter, etc.

In some embodiments, the fill structure 123 can be or include the same material as the functional structure 130. In some embodiments, the fill structure 123 can be formed of a material, including but not limited to, silicon oxide, etc. In some embodiments, the fill structure 123 can be formed of any material whose refractive index is lower than that of the material for the waveguide 125. For example, the fill structure 123 can have a refractive index lower than that of both the waveguide 125 and the functional structure 130. In some embodiments, the fill structure 123 can surround at least a portion of the waveguide 125. For example, as shown, the fill structure 123 can fill and/or surround side portions of the waveguide 125.

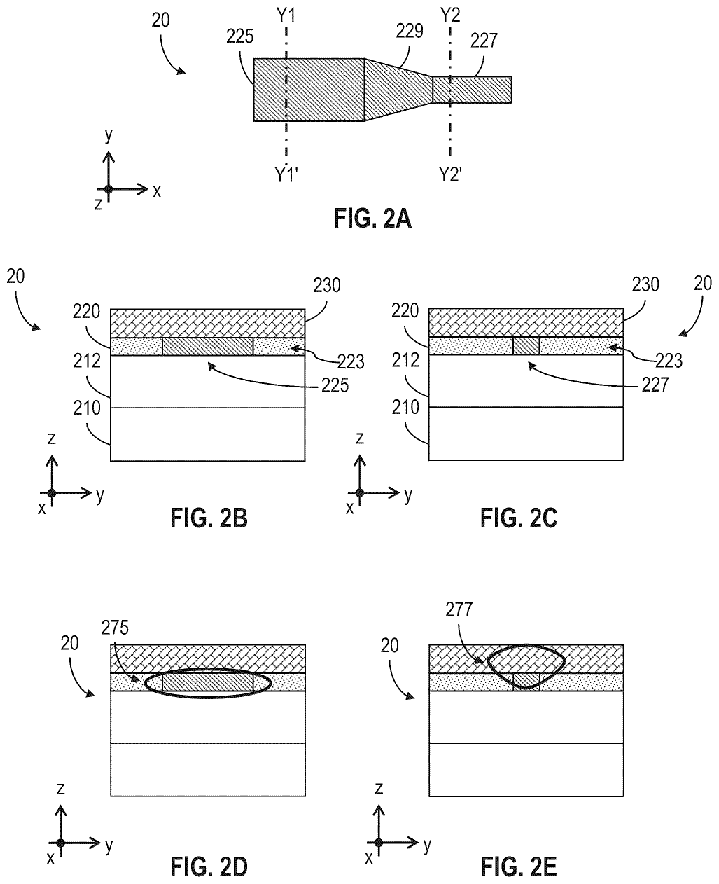

The functional structure 130 can be disposed on the waveguide layer 120. In some embodiments, the functional structure 130 can be disposed on the waveguide 125 and/or the fill structure 123 as shown, while optically connecting with the waveguide 125. In some embodiments, the waveguide 125 can have different cross sectional areas such that the functional structure 130 can connect differently with different portions of the waveguide 125 (e.g., as shown in FIG. 2D and FIG. 2E).

In some embodiments, the functional structure 130 is formed of a bulk material, including but not limited to, lithium niobate, barium titanate, lithium tantalate, or any material with optical properties (e.g., having functionalities such as amplification, electro-optical tuning, modulation, etc.) without departing from the scope of this disclosure. The functional structure 130 can be doped with a dopant that allows the functional structure 130 to have a functionality. The dopant includes any material that can impart functionalities (e.g., amplification, electro-optical tuning, modulation, etc.) without departing from the scope of this disclosure.

In some embodiments, the dopant can include, but is not limited to, rare earth elements (e.g., erbium, thulium, ytterbium, neodymium, praseodymium, holmium, samarium, europium, dysprosium, terbium, gadolinium, scandium, lanthanum, etc.), organic dyes (e.g., rhodamine, fluorescein, coumarin, cyanine dyes, etc.), chromophores (e.g., Disperse Red 1, Disperse Red 19, etc.), quantum dots (e.g., CdSe, PbS, InP, etc.), metallo-organic complexes (e.g., Ru(bpy)₃²⁺, Ir(ppy)₃, etc.), a combination thereof, etc. For example, the functional structure 130 can be formed of lithium niobate doped with erbium ions. In some embodiments, the doped functional structure 130 can be active (e.g., to provide amplification), non-linear (e.g., to provide electro-optical tuning), etc. In some embodiments, the doped functional structure 130 can have a combined functionality for both the amplification and the electro-optical tuning. In some embodiments, the functional structure 130 can be formed of a nonlinear material (e.g., polymers).

In some embodiments, the functionality can include, in response to receiving light, i) amplifying the light or ii) electro-optically tuning a characteristic of the light, the characteristic including one of an amplitude, a phase, a wavelength, a spectral property, and a dispersion property of the light. In some embodiments, the functional structure 130 can include a non-linear material. The functional structure 130 can be configured to exhibit a non-linear response to an optical and/or electrical signal. In some embodiments, the functionality of the functional structure 130 can include frequency modulation, phase modulation, etc.

The doped functional structure 130 can be driven by a signal to provide the functionality in various manners, thereby enhancing design and manufacturing flexibility. As discussed below, the functional structure 130 can be driven to activate the functionality in various manners (e.g., optically, electrically, electro-optically, thermally, magnetically, acoustically, chemically, mechanically, etc.) and then process a light (referred to as “light to be processed”), enabling the integration of multiple functions. For example, the functional structure 130 can include a surface (e.g., a top portion, etc.) to receive the signal configured to activate the functionality.

In some embodiments, the functional structure 130 can include a surface to receive an optical signal. The optical signal can be configured to optically activate the functional structure 130 to provide the functionality. For example, the functional structure 130 can receive, through the surface, the optical signal (e.g., from a laser source), which can alter the phase, amplitude, and/or spectral properties of the light to be processed (e.g., through the photorefractive effect, poling or sum frequency generation (SFG), difference frequency generation (DFG), etc.).

In some embodiments, the functional structure 130 can include an electrode to be electrically driven by an electrical signal provided through the electrode. The electrical signal can be configured to electrically activate the functional structure 130 to provide the functionality. For example, the functional structure 130 can receive, through the electrode, the electrical signal (e.g., voltage through the electrode), which can change the refractive index of the functional structure 130 (e.g., through the electro-optic (Pockels) effect) and thus modulate the light to be processed.

In some embodiments, the functional structure 130 can include a heating element configured to provide a thermal signal (e.g., heat to change a temperature of the functional structure 130). The thermal signal (and/or the temperature change) can be configured to thermally activate the functional structure 130 to provide the functionality. For example, the functional structure 130 can receive, through the heating element (e.g., a patterned resistive heating element, a thermoelectric cooler/heater, etc.), the thermal signal, which can induce the thermo-optic effect, thermal expansion, etc., and thus can modulate the phase and intensity of the light to be processed.

In some embodiments, the functional structure 130 can include a magnetic material configured to, in response to receiving a magnetic signal, change a polarization of the light to be processed. The magnetic signal (e.g., provided through a magnetic coil, magnetostrictive material, etc.) can be configured to activate the functional structure 130 to provide the functionality. For example, the magnetic signal can include the magneto-optic effects (e.g., the Faraday effect), which can change the polarization state of the light to be processed.

In some embodiments, the functional structure 130 can include a fluidic channel to provide a chemical signal (e.g., a chemical agent that causes a chemical reaction with the functional structure 130). The chemical signal can be configured to chemically activate the functional structure 130 to provide the functionality. For example, the chemical signal (e.g., chemical agents or gases) can be delivered through the microfluidic channel connected to the functional structure 130. The chemical reaction (and/or bonding change) can change the refractive index and/or structural properties of the functional structure 130, thereby modulating the light to be processed.

In some embodiments, the functional structure 130 can include a microelectromechanical system (MEMS) component configured to provide various signals. In some embodiments, the functional structure 130 can include the MEMS component to provide a mechanical signal (e.g., an external force such as a mechanical stress applied through an actuator). The mechanical signal can be configured to mechanically activate the functional structure 130 to provide the functionality. For example, the mechanical signal can change the refractive index of the functional structure 130 (e.g., through the mechanical deformation), thereby modulating the light to be processed.

In some embodiments, the mechanical signal can be an acoustic signal configured to acoustically activate the functional structure 130 to provide the functionality. For example, the acoustic signal (e.g., provided through a piezoelectric transducer) can modify the refractive index of the functional structure 130 (e.g., through the acousto-optic effect), and thus can modulate a direction (e.g., for beam steering) of the light to be processed.

In some embodiments, the functional structure 130 can include a piezoelectric component or material configured to, in response to receiving an electric field, convert the electric field into the mechanical signal discussed above, thereby piezoelectrically activating the functional structure 130 to provide the functionality.

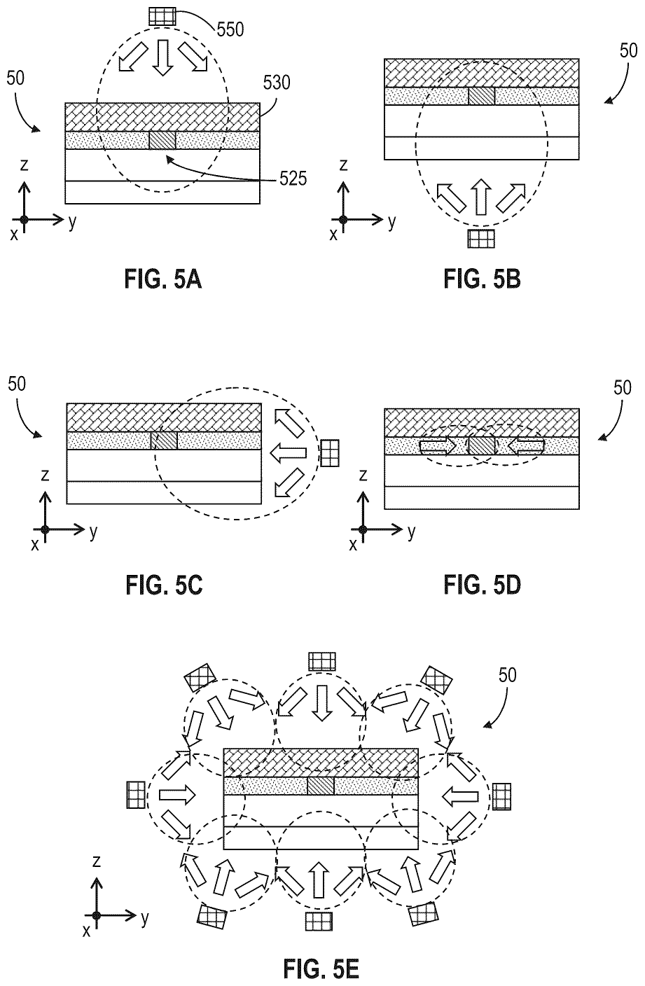

In some embodiments, the functional structure 130 can be driven by the signal as discussed herein, without receiving an external signal. As discussed below (e.g., optical signals discussed as non-limiting examples, with respect to FIGS. 5A-5E), the functional structure 130 can be configured to receive the signal from various portions of the functional structure 130.

By utilizing the doped functional structure (e.g., the functional structure 130), the PICS disclosed herein (e.g., the PIC 10) can enable the integration of various functional materials while enhancing the optical confinement and also mitigating the contamination risks. It should be appreciated, therefore that, various examples of the doped functional structures and/or the PICS can be implemented. The figures and description below are non-limiting examples of the PICS, which can be implemented as any of various other configurations while remaining within the scope of the present disclosure.

FIG. 2A depicts a top view of a portion of an example PIC 20, in accordance with various embodiments. FIG. 2B and FIG. 2C depict cross sectional views of the PIC 20 shown in FIG. 2A, in accordance with various embodiments. More specifically, FIG. 2B shows a cross section along the line Y1Y1′, and FIG. 2C shows a cross section along the line Y2Y2′. In some embodiments, the PIC 20 can be substantially similar to and/or incorporate features of the PIC 10. PIC 20 can include a substrate 210, base structure 212, a fill structure 223 of a waveguide layer 220, a first waveguide 225 and a second waveguide 227 of the waveguide layer 220, and a functional structure 230. PIC 20 shown in the figures here is simplified for illustrative purposes, and thus, can be implemented as any of various other configurations while remaining within the scope of the present disclosure. In some embodiments, PIC 20 can include more, fewer, or different components than shown in the figures.

In some embodiments, PIC 20 can include the first waveguide 225 and the second waveguide 227. Referring to FIG. 2A, the first waveguide 225 can be optically connected with the second waveguide 227. In some embodiments, the first waveguide 225 can optically connect with the second waveguide 227 at a first end, while optically connecting with an optical component (e.g., a third waveguide connected to another functional structure, a light source, a detector, a reflector, an optical filter, a grating, a splitter, etc.) at a second end. In some embodiments, the second waveguide 227 can optically connect with the first waveguide 225 at a first end, while optically connecting with an optical component (e.g., a fourth waveguide connected to another functional structure, a light source, a detector, a reflector, an optical filter, a grating, a splitter, etc.) at a second end.

The first waveguide 225 and the second waveguide 227 can have different cross sectional areas. In some embodiments, the first waveguide 225 can have a first cross sectional area, and the second waveguide 227 can have a second cross sectional area smaller than the first cross sectional area of the first waveguide 225. In some embodiments, the second cross sectional area of the second waveguide 227 can be larger than the first cross sectional area of the first waveguide 225. In some embodiments, the first waveguide 225 can be optically connected with the second waveguide 227 through a tapered waveguide portion 229. The tapered waveguide portion 229 can have a changing cross sectional area configured optically connect the first waveguide 225 with the second waveguide 227 having different cross sectional areas (e.g., as shown in FIG. 2A). For example, the tapered waveguide portion 229 can have a first cross sectional area that is equal to and/or optically matches the first cross sectional area of the first waveguide 225 at one end, while having a second cross sectional area that is equal to and/or optically matches the second cross sectional area of the second waveguide 227 at the other end.

The functional structure 230 can be doped with a dopant that allows the functional structure 230 to have a functionality. The functional structure 230 can include a surface to receive the signal configured to activate the functionality. In some embodiments, the functional structure 230 can be optically and/or electrically driven to provide the functionality. For example, in response to receiving light (e.g., through the second waveguide 227 or otherwise directed to the functional structure 230), the functional structure 230 can be optically and/or electrically driven to amplify the light. In response to receiving light (e.g., through the second waveguide 227 or otherwise directed to the functional structure 230), the functional structure 230 can be optically and/or electrically driven to modulate the light. In some embodiments, the light processed (e.g., amplified, modulated, etc.) by the functional structure 230 can be directed to an optical component (e.g., another functional structure, a detector, a reflector, an optical filter, a grating, a splitter, etc.), for example, through the second waveguide 227. For example, the functional structure 230 can receive light through the second waveguide 227, process (e.g., amplify, modulate, etc.) the light, and then reinsert the processed light into the second waveguide 227. While the optical and/or electrical signal is discussed as an example herein, in some embodiments, the signal can be or include a thermal signal, a magnetic signal, an acoustic signal, a chemical signal, a mechanical signal, etc., as discussed with respect to FIG. 1.

Referring to FIG. 2B and FIG. 2C, the functional structure 230 is shown to be located adjacent to (e.g., directly on) the second waveguide 227 and optically connected with the second waveguide 227. For example, as shown in FIG. 2C, the functional structure 230 can be disposed on the second waveguide 227 and/or the fill structure 223. In some embodiments, the functional structure 230 can be disposed above both the first waveguide 225 and the second waveguide 227 as shown in FIG. 2B and FIG. 2C. In some embodiments, although not depicted here, the functional structure 230 can be disposed only on the second waveguide 227 as discussed below.

As discussed above, the PIC 20 can have the first waveguide 225 and the second waveguide 227 having different cross sectional areas. Referring to FIG. 2D and FIG. 2E, this can control optical mode confinement associated with the waveguides (e.g., the first waveguide 225 and the second waveguide 227) and adjacent structures (e.g., the functional structure 230, etc.). FIG. 2D and FIG. 2E depict example optical mode profiles 275, 277 associated with the PIC 20 shown in FIG. 2B and FIG. 2C, respectively. The optical mode profiles 275, 277 shown here is simplified for illustrative purposes, and thus, can have any of various other profiles while remaining within the scope of the present disclosure. In some embodiments, as shown in the figures, the cross sectional area of the waveguides (e.g., the first waveguide 225 and the second waveguide 227) can change along the x axis. In some embodiments, as shown, the first cross sectional area of the first waveguide 225 can be reduced to the second cross sectional area of the second waveguide 227, thereby reducing the confinement within the second waveguide 227 (e.g., a smaller portion of the optical mode profile 277 is in the second waveguide 227) and allowing more of the optical mode profile to pass through the functional structure 230 (e.g., a larger portion of the optical mode profile 277 is in the functional structure 230). Likewise, in some embodiments, as shown, the second cross sectional area of the second waveguide 227 can be increased to the first cross sectional area of the first waveguide 225, thereby increasing the confinement within the first waveguide 225 (e.g., a larger portion of the optical mode profile 257 is in the first waveguide 225) and allowing more of the optical mode profile to pass through the first waveguide 226. In some embodiments, any various changes of the cross sectional areas can be implemented to control the optical mode profiles in the first waveguide 225, the second waveguide 227, and the functional structure 230. Although discussed with respect to the cross sectional areas, the first waveguide 225, the second waveguide 227, etc. (e.g., a shape, dimension, etc.) can be designed to control the optical mode profiles 275, 277. For example, a material or structure that can be controlled to have a varying refractive index can be utilized for the first waveguide 225, the second waveguide 227, the fill structure 223, etc. to control the optical mode profiles 275, 277.

As mentioned above, in some embodiments, although not depicted here, the functional structure 230 can be disposed only on the second waveguide 227. In some embodiments, while the functional structure 230 is disposed above the second waveguide 227, a different material or structure can be formed on the first waveguide 225. For example, a material or structure that can enhance the confinement of the optical mode profile 275 within the first waveguide 225 can be formed on the first waveguide 225 to improve the optical mode confinement. For example, a material or structure that is undoped can be formed on the first waveguide 225, while the material or structure that is doped can be formed on the second waveguide 227.

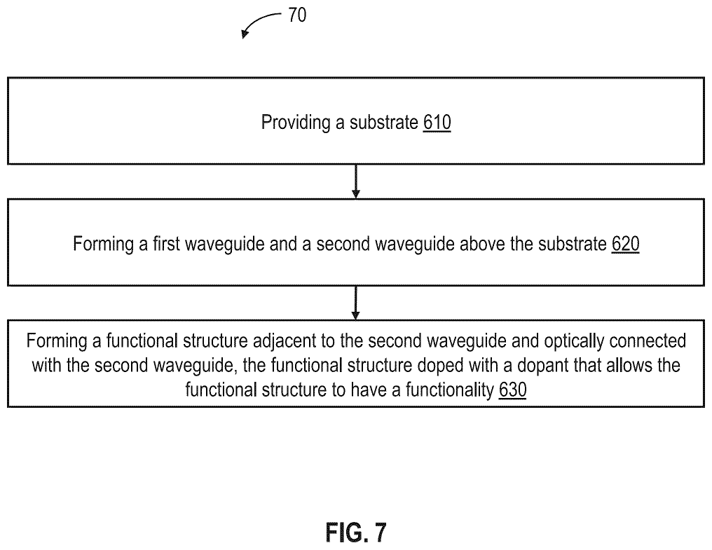

As discussed above, the techniques disclosed herein can allow the PICs (e.g., the PICs 10, 20), to integrate with various functional materials while enhancing the optical confinement, without damaging the waveguide (e.g., the first waveguide 225, the second waveguide 227, etc.) or propagation loss therefrom. The PIC 20 can be configured such that the functional structure 230 can serve as an optical component to process light while the waveguides (e.g., the first waveguide 225, the second waveguide 227, etc.) can serve as an interconnect component to optically connect the different optical components. As such, the PIC 20 (e.g., the functional structure 230, the first waveguide 225, the second waveguide 227, etc.) can be configured to serve as a unit PIC component that can be integrated with other components in flexible manners, thereby allowing for modular manufacturing and opening up the possibilities for mix-and-match configurations (e.g., as discussed with respect to FIG. 7). By integrating such PICs, for example, by combining various waveguides and functional structures with different functionalities (e.g., amplification, lasing, tuning, modulation, combination thereof, etc.), the PICs can be configured to perform complex operations. The figures and description below are non-limiting examples of such PICs, which can be implemented as any of various other configurations while remaining within the scope of the present disclosure.

FIG. 3A depicts a top view of a portion of an example PIC 30, in accordance with various embodiments. In some embodiments, the PIC 30 can incorporate features of the PIC 20. For example, the PIC 30 can be a PIC in which a first version of the PIC 20 (referred to as “first PIC 20A” hereinafter) and a second version of the PIC 20 (referred to as “second PIC 20B) are optically connected with each other. As shown, the first PIC 20A can include a first waveguide 325A, a tapered waveguide portion 329A, a second waveguide 327A, and a functional structure 330A. The second PIC 20B can include a first waveguide 325B, a tapered waveguide portion 329B, a second waveguide 327B, and a functional structure 330B. Although the functional structures of the PIC 30 are disposed above the waveguides (e.g., as shown in FIG. 2B), the first waveguides 325A, 325B, the second waveguides 327A, 327B, and the tapered waveguide portions 329A, 329B are shown for purposes of explanation. The PIC 30 shown in the figures here is simplified for illustrative purposes, and thus, can be implemented as any of various other configurations while remaining within the scope of the present disclosure. In some embodiments, the PIC 30 can include more, fewer, or different components than shown in the figures.

In some embodiments, one or more components of the first PIC 20A and corresponding one or more components of the second PIC 20B can share a same dimension, shape, material, etc. For example, the first PIC 20A can be a replica of the second PIC 20B, in which the PIC 20A is optically connected with the PIC 20B through the waveguide (e.g., the waveguides 327A, 327B, which can be a single waveguide). In some embodiments, one or more components of the first PIC 20A are different from corresponding one or more components of the second PIC 20B in dimension, shape, material, etc.

In some embodiments, the functional structure 330A can have a first functionality, and the functional structure 330B can have a second functionality. In some embodiments, one of the functional structure 330A or the functional structure 330B can be doped with a dopant that allows the doped functional structure to have a corresponding functionality. In some embodiments, both of the functional structure 330A and the functional structure 330B can be doped. In some embodiments, both of the functional structure 330A and the functional structure 330B can be doped with a same dopant. In some embodiments, the functional structure 330A and the functional structure 330B can be doped with different dopants. For example, the functional structure 330A can be doped with a first dopant to provide a first functionality, and the functional structure 330B can be doped with a second dopant to provide a second functionality. In some embodiments, the first functionality can be the same as the second functionality. In some embodiments, the first functionality can be different from the second functionality. For example, the first functionality of the functional structure 330A can be amplifying light, while the second functionality of the functional structure 330B can be modulating light. For example, the first functionality of the functional structure 330A can be amplifying light, while the second functionality of the functional structure 330B can be amplifying light but with a different amplification state.

In some embodiments, one of the functional structure 330A or the functional structure 330B can be configured to be driven by the signal (e.g., an optical signal, an electrical signal, a thermal signal, a magnetic signal, an acoustic signal, a chemical signal, a mechanical signal, etc.) to provide the corresponding functionality. In some embodiments, both of the functional structure 330A and the functional structure 330B can be configured to be driven by the signal to provide the corresponding functionality. In some embodiments, the functional structure 330A can be configured to be driven by a first signal (e.g., an optical signal, etc.), while the functional structure 330B can be configured to be driven by a second signal (e.g., an electrical signal, etc.).

In some embodiments, the functional structure 330A can be configured to process (e.g., amplify, modulate, etc.) light based on the functionality, and can direct a processed light to the functional structure 330B through the waveguides 327A, 327B. As shown in FIG. 3A, the functional structure 330A can be optically connected with the functional structure 330B through the first waveguides 327A, 327B, through which the processed light can be directed. The first waveguides 327A, 327B can be vertically disposed relative to the functional structure 330A and the functional structure 330B, while optically connecting the functional structure 330A with the functional structure 330B.

In some embodiments, although not shown, the PICs (e.g., the PIC 30) disclosed herein can be or include a multilayer circuit, in which any number of PICs (e.g., the PIC 20A, the PIC 20B, the PIC 30, etc.), any number of functional structures (e.g., the functional structure 330A, the functional structure 330B, etc.) and/or any number of waveguides (e.g., the waveguide 325A, the waveguide 325B, etc.) can be optically interconnected. For example, the functional structure 330A can be optically connected with and vertically disposed relative to the functional structure 330B. For example, a PIC can include a plurality of waveguide layers (e.g., the waveguide layers 120, 220, etc.) and one or more functional structures disposed between the plurality of waveguide layers.

FIG. 3B depicts a top view of a portion of an example PIC 35, in accordance with various embodiments. In some embodiments, the PIC 35 can incorporate features of the PIC 30. For example, the PIC 35 can be a PIC in which the first PIC 20A, the second PIC 20B, a third version of the PIC 20 (referred to as “third PIC 20C” hereinafter) and a fourth version of the PIC 20 (referred to as “fourth PIC 20D) are optically connected with each other. As with FIG. 3A, although the functional structures are disposed above the waveguides, the waveguides are shown for purposes of explanation. The PIC 35 shown in the figures here is simplified for illustrative purposes, and thus, can be implemented as any of various other configurations while remaining within the scope of the present disclosure. In some embodiments, the PIC 35 can include more, fewer, or different components than shown in the figures.

The PIC 35 can include any number of PICs (e.g., the PIC 20, the PIC 30, etc.), which can be arranged in various manners. As shown in FIG. 3B, in some embodiments, the PIC 35 can be a PIC, in which a first version of the PIC 30 is optically connected with a second version of the PIC 30. In some embodiments, the PIC 35 can be a PIC, in which a first version of the PIC 20, a second version of the PIC 20, a third version of the PIC 20, and a fourth version of the PIC 20 are optically connected with each other. In some embodiments, the PIC 35 can include any number of PICs (e.g., the PIC 20, the PIC 30, etc.) optically connected (e.g., in series, as shown, or in parallel (not shown)) with the first PIC 20A. For example, the third PIC 20C can be optically connected with the second PIC 20B in series.

In some embodiments, the functional structures of the first and second PICs 20A, 20B can have a first functionality (e.g., amplification), while the functional structures of the third and fourth PICs 20C, 20D can have a second functionality (e.g., modulation). In some embodiments, the functional structures of the first and second PICs 20A, 20B can be doped with a first dopant to provide the first functionality (e.g., amplification), while the functional structures of the third and fourth PICs 20C, 20D can be doped with a second dopant to provide the second functionality (e.g., modulation). In some embodiments, the functional structures of the first and second PICs 20A, 20B can be doped with a dopant, while the functional structures of the third and fourth PICs 20C, 20D are not doped. Of course, as discussed with respect to FIG. 3A, each of the functional structures of the PICs 20A, 20B, 20C, 20D can have different functionalities and/or can be doped with different dopants.

As discussed above, the techniques disclosed herein can enable integration of PICs having different functionalities for various applications (e.g., optical amplifiers, tunable lasers, wavelength converters, optical modulators, photodetectors, quantum photonic devices, multifunctional PICs, etc.). For example, the functional structure (e.g., aluminum oxide) can be doped (e.g., with erbium) to amplify light (e.g., an optical signal) for C-band amplification. For example, the functional structure including a non-linear material (e.g., lithium niobate) can be configured to electro-optically tune light (e.g., covert wavelengths), which can be utilized for a tunable laser source. For example, the functional structure (e.g., barium titanate-based structure) can be utilized as a high-speed modulator to electro-optically tune and/or modulate light. For example, the functional structure (e.g., including germanium-based) can be utilized as a photodetector for near-infrared detection by integrating a material sensitive to specific wavelengths to detect light. For example, the functional structure (e.g., including silicon carbide) can be utilized as a quantum computing and communication device, including single-photon sources, detectors, etc. For example, the functional structure can be utilized as an integrated system for optical signal processing, by combining various functionalities (e.g., amplification, modulation, detection, etc.) within a single chip. For example, the functional structure can be utilized as a high-power optical device (e.g., high-power amplifiers, high power modulators, etc.), by leveraging the large mode area to overcome the optical power constraints. The PICs disclosed herein can be optically and/or electrically driven (e.g., pumped to activate the functionalities, etc.) in various manners, as discussed below, enabling the integration of multiple functions and thus improve design and manufacturing flexibility.

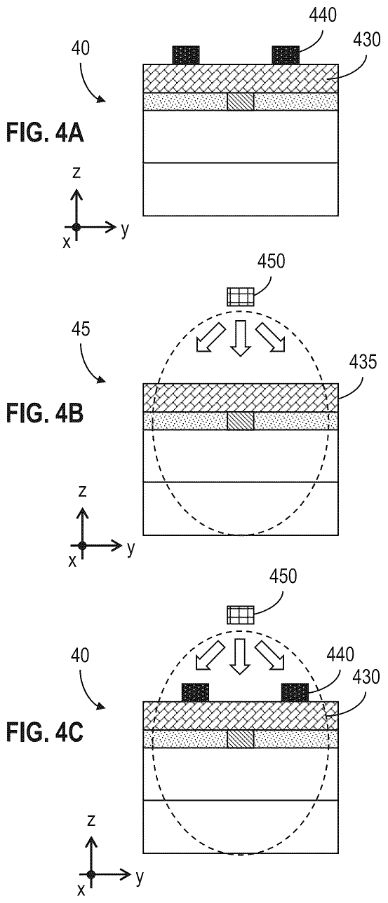

FIG. 4A, FIG. 4B, and FIG. 4C depict cross sectional views of example implementations of a PIC, in accordance with various embodiments. More specifically, FIG. 4A shows a portion of an example PIC 40, in accordance with various embodiments. The PIC 40 can be substantially similar to or incorporate features of the PICs 20, 30, 35, etc. For example, the PIC 40 can be a portion of the PICs 20, 30, 35, etc. As shown, the PIC 40 can include a functional structure 430 and an electrode 440. The PIC 40 shown in the figure here is simplified for illustrative purposes, and thus, can be implemented as any of various other configurations while remaining within the scope of the present disclosure. In some embodiments, the PIC 40 can include more, fewer, or different components than shown in the figures.

In some embodiments, the electrode 440 can be disposed on the functional structure 430. In some embodiments, the electrode 440 can be formed on the functional structure 430 by patterning the functional structure 430. The electrode 440 can be configured to receive an electrical signal (e.g., voltage, etc.) and provide the electrical signal to the functional structure 430. The functional structure 430 can be electrically driven by the electrical signal provided through the electrode 440. For example, in response to receiving light, the functional structure 430 can electrically tune the light based on the electrical signal. As discussed above, the PIC 40 can be a portion of the PICs 20, 30, 35, etc. That is, in some embodiments, the light processed (e.g., tuned) by the functional structure 430 can be directed to the other optical component (e.g., the other functional structure, etc.) in the PIC. For example, the light tuned by the functional structure 430 can be directed to the other functional structure configured to amplify the tuned light.

FIG. 4B shows a portion of an example PIC 45, in accordance with various embodiments. The PIC 45 can be substantially similar to or incorporate features of the PICs 20, 30, 35, etc. For example, the PIC 45 can be a portion of the PICs 20, 30, 35, etc. As shown, the PIC 45 can include a functional structure 435. The PIC 45 shown in the figure here is simplified for illustrative purposes, and thus, can be implemented as any of various other configurations while remaining within the scope of the present disclosure. In some embodiments, the PIC 45 can include more, fewer, or different components than shown in the figures.

The functional structure 435 can be optically driven by an optical signal provided by a light source 450 (e.g., a light emitting diode, etc.). For example, in response to receiving light from the light source 450, the functional structure 435 can amplify the light based on the optical signal. As discussed above, the PIC 45 can be a portion of the PICs 20, 30, 35, etc. That is, in some embodiments, the light processed (e.g., amplified) by the functional structure 435 can be directed to the other optical component (e.g., the other functional structure, etc.) in the PIC. For example, the light amplified by the functional structure 435 can be directed to the other functional structure configured to tune the amplified light.

Referring to FIG. 4C, the PIC 40 is shown. As opposed to the PIC 40 shown in FIG. 4A, the functional structure 430 shown in FIG. 4C can be further configured to be optically driven by the light source 450. That is, in some embodiments, the functional structure 430 can be electro-optically driven by the electrical signal provided through the electrode 440 and the optical signal provided by the light source 450. For example, in response to receiving light, the functional structure 430 can electro-optically amplify and/or tune the light based on the electrical signal and light signal. As discussed above, the PIC 40 shown in FIG. 4C can be a portion of the PICs 20, 30, 35, etc. That is, in some embodiments, the light processed (e.g., amplified and/or tuned) by the functional structure 430 can be directed to the other optical component (e.g., the other functional structure, etc.) in the PIC for further processing.

Although the PICs 40, 45 are discussed as non-limiting examples, the PICs discussed herein can include various features to receive the signal (e.g., an optical signal, an electrical signal, a thermal signal, a magnetic signal, an acoustic signal, a chemical signal, a mechanical signal, etc.) as discussed with respect to FIG. 1. For example, the PICs discussed herein can include a heating element, a magnetic material, a fluidic channel, a MEMS component, a piezoelectric component or material, etc.

FIG. 5A, FIG. 5B, FIG. 5C, FIG. 5D, and FIG. 5E depict cross sectional views of example implementations of a PIC, in accordance with various embodiments. More specifically, shown in the figures are implementations of an example PIC 50 configured to be optically driven by a light source 550 in various manners. The PIC 50 can be substantially similar to or incorporate features of the PICs 20, 30, 35, etc. For example, the PIC 50 can be a portion of the PICs 20, 30, 35, etc. As shown, the PIC 50 can include a functional structure 530 and a waveguide 525. The PIC 50 shown in the figure here is simplified for illustrative purposes, and thus, can be implemented as any of various other configurations while remaining within the scope of the present disclosure. In some embodiments, the PIC 50 can include more, fewer, or different components than shown in the figures.

As shown in FIG. 5A to FIG. 5E, the PIC 50 can be configured to be optically driven by the light source 550, from various portions of the PIC 50. In some embodiments, the PIC 50 and/or the functional structure 530 can include a surface to receive an optical signal from the light source 550. In some embodiments, the surface can be configured to receive the optical signal from a top portion of the functional structure 530 (e.g., as shown in FIG. 5A). This can allow for enhanced interaction, for example, between the optical signal and the functional structure 530. In some embodiments, the surface can be configured to receive the optical signal from a bottom portion of the functional structure 530 (e.g., as shown in FIG. 5B). In some embodiments, the surface can be configured to receive the optical signal from a side portion of the functional structure 530 (e.g., as shown in FIG. 5C). In some embodiments, the surface can be configured to receive the optical signal from an inside portion (e.g., in-plane) of the functional structure 530 and/or the PIC 50 (e.g., from the waveguide structure, as shown in FIG. 5D). The surface can be configured to receive the optical signal from any combination of the configuration discussed above. For example, the functional structure 530 can be configured to receive the optical signal from a plurality of light sources 550 (e.g., as shown in FIG. 5E) that are surrounding the functional structure 530.

As discussed above, the PICs disclosed herein can optically connect with various optical components, including but not limited to, a light source, a detector, a reflector, an optical filter, a grating, a splitter, etc. The figures and description below are non-limiting examples of such PICS, which can be implemented as any of various other configurations while remaining within the scope of the present disclosure.

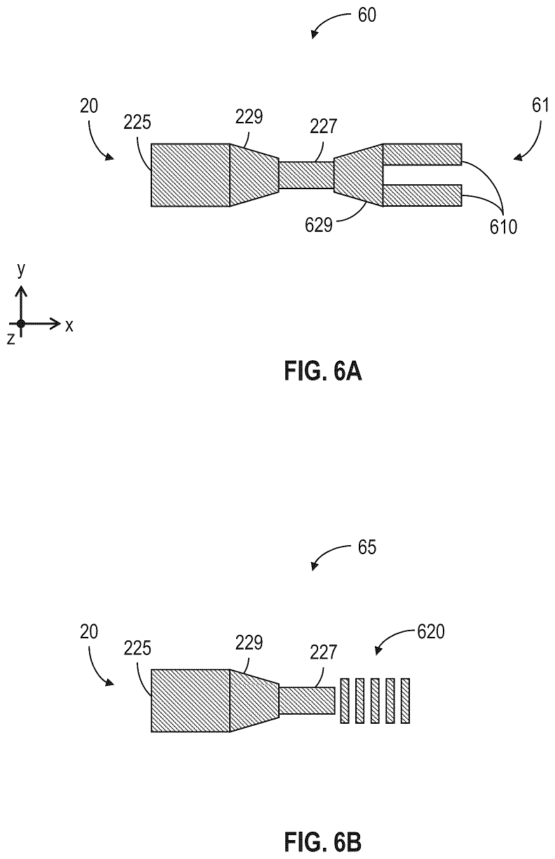

FIG. 6A depicts a top view of a portion of an example PIC 60, in accordance with various embodiments. The PIC 60 can be substantially similar to or incorporate features of the PICs 20, 30, 35, etc. In some embodiments, as shown, the PIC 60 can be a PIC, in which the PIC 20 is optically connected to an optical component 61. The optical component 61 includes a tapered waveguide 629 and branches 610. The PIC 60 shown in the figure here is simplified for illustrative purposes, and thus, can be implemented as any of various other configurations while remaining within the scope of the present disclosure. In some embodiments, the PIC 60 can include more, fewer, or different components than shown in the figures.

As shown in FIG. 6A, the branches 610 can be optically connected with the second waveguide 227, which is optically connected with the functional structure 230 (as shown in FIG. 2C). That is, the branches 610 can be optically connected with the functional structure 230. In some embodiments, the branches 610 can receive a light from the functional structure 230 (e.g., through the waveguide 227 and the tapered waveguide 629). For example, the functional structure 230 can process (e.g., amplify, tune, modulate, etc.) a light, and then direct the processed light to the branches 610. In some embodiments, the branches 610 can serve as a splitter to split the processed light and direct the split lights into different optical paths (e.g., through an upper branch and a lower branch). In some embodiments, the branches 610 can serve as a combiner. For example, the branches 610 can receive a plurality of lights from different optical paths (e.g., from the upper branch and the lower branch), combine the plurality of lights, and then direct the combined light to the second waveguide 227. In some embodiments, the branches 610 can direct the combined light to the functional structure 230 (e.g., through the tapered waveguide 629 and the second waveguide 227).

FIG. 6B depicts a top view of a portion of an example PIC 65, in accordance with various embodiments. The PIC 65 can be substantially similar to or incorporate features of the PICs 20, 30, 35, etc. In some embodiments, as shown, the PIC 65 can be a PIC, in which the PIC 20 is optically connected to a grating 620. The PIC 65 shown in the figure here is simplified for illustrative purposes, and thus, can be implemented as any of various other configurations while remaining within the scope of the present disclosure. In some embodiments, the PIC 65 can include more, fewer, or different components than shown in the figures.

As shown in FIG. 6B, the grating 620 can be optically connected with the second waveguide 227, which is optically connected with the functional structure 230 (as shown in FIG. 2C). That is, the grating 620 can be optically connected with the functional structure 230. In some embodiments, the grating 620 can receive a light from the functional structure 230 (e.g., through the waveguide 227) and manipulate the light based on the grating equation. For example, the functional structure 230 can process (e.g., amplify, tune, modulate, etc.) the light, and then direct the processed light to the grating 620. The grating 620 can manipulate (e.g., reflect, transmit, direct, steer, etc.) the processed light depending on the design of the grating 620 (e.g., a period, a duty cycle, a material, etc.). In some embodiments, the grating 620 can receive the light and then direct the light to the second waveguide 227.

Although not shown, the PICs 60, 61 can include other optical components optically connected with the second waveguide 227. In some embodiments, the PICs 60, 61 can include an optical coupler (e.g., a multi-mode interference (MMI) coupler, a n×m coupler, etc.), a polarization rotator, a detector, a light source, etc. optically integrated therein (e.g., optically connected with the second waveguide 227).

FIG. 7 depicts a flow chart of an example method 70 of manufacturing an example PIC, in accordance with various embodiments. At least one of operations in the method 70 can be used to form the PICs disclosed herein (e.g., the PICs 10, 20, 30, 35, 40, 45, 50, etc.) or at least a portion thereof. It is noted that the method 70 is a non-limiting example. Accordingly, it should be understood that additional operations may be provided before, during, and/or after the method 70 of FIG. 7, and that some other operations may only be briefly described herein. In some embodiments, the method 70 can include more, fewer, or different operations than shown in FIG. 7.

In a brief overview, the method 70 begins with operation 710 of providing a substrate. The method 70 continues to operation 720 of forming a first waveguide and a second waveguide above the substrate. The method 70 further continues to operation 730 of forming a functional structure adjacent to the second waveguide and optically connected with the second waveguide, the functional structure doped with a dopant that allows the functional structure to have a functionality.

At operation 710, the substrate (e.g., the substrate 110) can be provided. In some embodiments, at operation 710, the substrate, including a wafer or any structure on which a waveguide, a functional structure, etc., can be formed, is provided. For example, the substrate including a base structure (e.g., the base structure 112) can be provided.

At operation 720, a first waveguide (e.g., the first waveguide 225) and a second waveguide (e.g., the second waveguide 227) is formed above the substrate. The first waveguide and the second waveguide can be formed on the substrate while optically connected with each other. In some embodiments, the first waveguide and the second waveguide can be formed such that cross sectional areas of the waveguides are different from each other. For example, the first waveguide can be formed with a first cross sectional area, and the second waveguide can be formed with a second cross sectional area. In some embodiments, the first cross sectional area can be larger than that of the second cross sectional area. In some embodiments, a tapered waveguide portion (e.g., the tapered waveguide portion 229) can be formed to optically connect the first waveguide with the second waveguide. In some embodiments, at operation 720, the method 70 can include forming a fill structure (e.g., the fill structure 123).

At operation 730, a functional structure (e.g., the functional structure 230) can be formed adjacent to (e.g., directly on) the second waveguide and optically connected with the second waveguide. In some embodiments, the functional structure can be formed directly on the second waveguide. For example, the functional structure can be deposited or transferred directly on the second waveguide. The functional structure can be doped with a dopant (e.g., erbium, thulium, ytterbium, or any material that can impart functionalities, such as amplification, electro-optical tuning, modulation, etc.) that allows the functional structure to have a functionality, while having a surface configured to receive a signal (e.g., an optical signal, an electrical signal, a thermal signal, a magnetic signal, an acoustic signal, a chemical signal, a mechanical signal, etc.) configured to activate the functionality.

In some embodiments, the functional structure can be formed adjacent to (e.g., directly on) the second waveguide by depositing a functional material (e.g., lithium niobate, barium titanate, lithium tantalate, or any material with optical properties having functionalities such as amplification, electro-optical tuning, modulation, etc.) and implanting the dopant into the functional material. In some embodiments, the functional structure can be formed by transferring the functional structure doped with the dopant onto the second waveguide. For example, the functional structure can be separately formed on a second substrate, and then can be wafer-bonded onto the waveguide (e.g., or a layer thereof). In some embodiments, at operation 730, the method 70 can include forming the fill structure. In some embodiments, the fill structure can be or include a same material as the functional structure. For example, the same material for the functional structure and the fill structure can be deposited in a same step.

As discussed above, the functional structure can be formed independently from the waveguide. For example, the functional structure can be formed (e.g., fabricated, processed, etc.) separately from the waveguide. As such components (e.g., the functional structure, the waveguide) can serve as unit PIC components, this independence allows for modular manufacturing, opening up the possibilities for mix-and-match configurations. As a non-limiting example, in some embodiments, at operation 730, a plurality of functional structures can be formed, and then transferred onto a plurality of corresponding waveguides. The corresponding waveguides can be optically connected with each other, thereby forming a PIC to achieve various functionalities of the functional structures. In some embodiments, a plurality of first functional structures having a first functionality can be formed, and a plurality of second functional structures having a second functionality can be formed, separately from the first functional structures. One of the first functional structures and/or one of the second functional structures can be selectively transferred onto one or more waveguides, based on the purpose of the PIC formed thereby. For example, the first functionality of the first functional structure can be, in response to receiving light, amplifying the light, and the second functionality of the second functional structure can be, in response to receiving light, modulating the light. The first functional structure can be selectively transferred onto the waveguide of the PIC to form an amplification circuit. The second functional structure can be selectively transferred onto the waveguide of the PIC to form a modulation circuit. The first and the second functional structures can be transferred on to one or more waveguides of the PIC to form a circuit configured to amplify and/or modulate the light.

In some embodiments, when transferring the functional structure doped with the dopant onto the second waveguide, the method 70 can include bonding a surface of the functional structure with a surface of the second waveguide, and annealing the bonded surfaces. In some embodiments, the method 70 can further include planarizing the surface of the functional structure and/or the surface of the second waveguide prior to bonding.

In some embodiments, the surfaces can be directly bonded. The method 70 can include cleaning and/or polishing the surfaces, and then bring the surfaces (e.g., at room temperature) contact. The method 70 can further include annealing at a higher temperatures (e.g., 300 to 500° C.) to strengthen the surface bonding. In some embodiments, the method 70 can include activating the surfaces (e.g., with a plasma of oxygen, argon, etc.) prior to bonding.

In some embodiments, the surfaces can be adhesively bonded. The method 70 can include applying an adhesive layer (e.g., benzocyclobutene (BCB), epoxy, etc.) to one of the surfaces, and then bring the surfaces contact. In some embodiments, the method 70 can further include curing the surfaces thermally or using ultraviolet light.

In some embodiments, plasma-assisted bonding can be performed to bond the surfaces. The method 70 can include activating the surfaces (e.g., using oxygen or argon plasma to enhance the surface energy), and then bring the surfaces contact. In some embodiments, the method 70 can further include annealing the bonded surfaces (e.g., at 100 to 300° C.). In some embodiments, the method 70 can include planarizing the surfaces using a chemical mechanical planarization (CMP) process.

In some embodiments, anodic bonding can be performed to bond the surfaces. The method 70 can include applying a high voltage across the surfaces while the surfaces are in contact (e.g., at 200 to 400° C.), thereby forming the anodic bonding between the surfaces.

In some embodiments, ion slicing and/or smart cut processes can be performed during the bonding process discussed above. For example, the functional structure can be ion implanted and bonded to a substrate wafer. After bonding the functional structure to the substrate wafer, the bonded structure can be annealed to break apart at an ion sliced interface. In some embodiments, the processed functional structure can be further processed to a desired thickness. For example, the processed functional structure can be ground and/or polished to achieve a desired surface thickness.

This modularity can simplify the manufacturing process by decoupling the fabrication of the waveguides from the fabrication of the functional structures. As a result, chemically aggressive processes (e.g., patterning, ion implantation, doping, etc.) on the waveguide can be eliminated, reducing the risk of defects while improving the overall yield, while allowing for various complex functionalities. Furthermore, the techniques discussed herein allow for greater flexibility in design, enabling the customization of PICs for various applications by simply selecting and combining different pre-fabricated functional structures and waveguides. This mix-and-match capability can enable faster prototyping and production cycles, as well as more cost-effective manufacturing.

In some embodiments, the method 70 can include forming a second functional structure (e.g., the functional structures 330A, 330B, etc.) optically connected with the first waveguide (e.g., the waveguides 327A, 327B, etc.). The second functional structure can have a second functionality. In some embodiments, the second functionality can be the same as the first functionality of the functional structure (hereinafter referred to as the first functional structure). In some embodiments, the second functionality can be different from the first functionality of the first functional structure.

In some embodiments, the method 70 can include forming the first functional structure doped with a dopant and forming the second functional structure without doping. In some embodiments, the method 70 can include masking an area for the second functional structure during the ion implantation process (e.g., for doping the first functional structure).

In some embodiments, the method 70 can include forming the second functional structure and/or the waveguide such that the second functional structure and/or the waveguide can be vertically disposed relative to the first functional structure. For example, the second functional structure and/or the waveguide can be formed on the first functional structure while optically connected therewith. This vertical configuration (e.g., multilayer PICs including the waveguides, the functional structures, etc.) can enable advanced functionalities while eliminating need for complex and/or chemically aggressive processes (e.g., ion implantation, doping, etc.) on the waveguide, making the manufacturing process more efficient and scalable.

In some embodiments, the method 70 can include forming a third functional structure (e.g., the functional structures of the PICs 20A, 20B, 20C, etc.) optically connected with the functional structure in series or in parallel. The third functional structure can have a third functionality. In some embodiments, the third functionality can be the same as the functionalities of the first functional structure and/or the second functional structure. In some embodiments, the third functionality can be different from the functionalities of the first functional structure and/or the second functional structure.

In some embodiments, the method 70 can include forming an electrode (e.g., the electrode 440) on the functional structure. In some embodiments, the electrode can allow the functional structure to be electrically driven by an electrical signal provided through the electrode. For example, the functional structure can be electrically driven by the electrical signal while optically driven by an optical signal.

In some embodiments, the method 70 can include planarizing a surface (e.g., of the substrate, the base structure, the waveguide, etc.) before, after, and/or during any of the operations in the method 70.

The foregoing description of illustrative embodiments has been presented for purposes of illustration and of description. It is not intended to be exhaustive or limiting with respect to the precise form disclosed, and modifications and variations are possible in light of the above teachings or can be acquired from practice of the disclosed embodiments.

While certain embodiments have been illustrated and described, it should be understood that changes and modifications can be made therein in accordance with ordinary skill in the art without departing from the technology in its broader aspects as defined in the following claims.

The embodiments, illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, compounds, compositions or systems, which can of course vary. It is also to be understood that the terminology used herein is for the purpose of describing particular embodiments only, and is not intended to be limiting.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

Additional embodiments can be set forth in the following claims.

What is claimed is:

1. A photonic integrated circuit, comprising:
a first waveguide;
a second waveguide optically connected with the first waveguide; and
a functional structure disposed adjacent to the second waveguide and optically connected with the second waveguide, the functional structure doped with a dopant that allows the functional structure to have a functionality, the functional structure including a surface to receive a signal configured to activate the functionality.

2. The photonic integrated circuit of claim 1, wherein a first cross sectional area of the first waveguide is larger than a second cross sectional area of the second waveguide, the photonic integrated circuit further comprising a tapered waveguide portion optically connecting the first waveguide with the second waveguide.

3. The photonic integrated circuit of claim 1, wherein the surface is configured to receive the signal from at least one of:
a top portion of the functional structure;
a bottom portion of the functional structure;
a side portion of the functional structure; or
an inside portion of the functional structure.

4. The photonic integrated circuit of claim 1, wherein the functional structure is configured to be driven by the signal to provide the functionality, the signal including one of:
an optical signal configured to optically activate the functional structure to provide the functionality;
an electrical signal configured to electrically activate the functional structure to provide the functionality;
a thermal signal configured to thermally activate the functional structure to provide the functionality;
a magnetic signal configured to magnetically activate the functional structure to provide the functionality;
an acoustic signal configured to acoustically activate the functional structure to provide the functionality;
a chemical signal configured to chemically activate the functional structure to provide the functionality; or
a mechanical signal configured to mechanically activate the functional structure to provide the functionality.

5. The photonic integrated circuit of claim 1, further comprising a second functional structure optically connected with the first waveguide, the second functional structure having a second functionality.

6. The photonic integrated circuit of claim 5, further comprising an optical component optically connected to the first functional structure or the second functional structure, the optical component including one of: a splitter, an optical combiner, an optical coupler, a grating, a polarization rotator, a detector, or a light source.

7. The photonic integrated circuit of claim 1, wherein the functionality comprises, in response to receiving light, i) amplifying the light or ii) tuning a characteristic of the light, the characteristic including one of an amplitude, a phase, a wavelength, a spectral property, or a dispersion property of the light.

8. The photonic integrated circuit of claim 1, wherein the functional structure includes a non-linear material.

9. A device, comprising:
a first functional structure having a first functionality;
a second functional structure having a second functionality; and
a waveguide vertically disposed relative to the first functional structure and the second functional structure, the waveguide optically connecting the first functional structure with the second functional structure,
wherein one of the first functional structure or the second functional structure is doped with a dopant that allows the one of the first functional structure or the second functional structure to have a corresponding functionality.

10. The device of claim 9, wherein each of the first functionality and the second functionality comprises, in response to receiving light, to i) amplifying the light or ii) tuning a characteristic of the light, the characteristic including one of an amplitude, a phase, a wavelength, a spectral property, or a dispersion property of the light.

11. The device of claim 9, wherein the first functionality is different from the second functionality.

12. The device of claim 9, wherein one of the first functional structure or the second functional structure is configured to be driven by a signal to provide the corresponding functionality, the signal including one of:
an optical signal configured to optically activate the functional structure to provide the functionality;
an electrical signal configured to electrically activate the functional structure to provide the functionality;
a thermal signal configured to thermally activate the functional structure to provide the functionality;
a magnetic signal configured to magnetically activate the functional structure to provide the functionality;
an acoustic signal configured to acoustically activate the functional structure to provide the functionality;
a chemical signal configured to chemically activate the functional structure to provide the functionality; or
a mechanical signal configured to mechanically activate the functional structure to provide the functionality.

13. The device of claim 9, wherein the one of the first functional structure or the second functional structure includes one of:
a surface to receive an optical signal;
an electrode to be electrically driven by an electrical signal provided through the electrode;
a heating element configured to change a temperature of the one of the first functional structure or the second functional structure;
a magnetic material configured to change a polarization of a light in response to receiving a magnetic signal;
a fluidic channel to provide a chemical agent that causes a chemical reaction with the one of the first functional structure or the second functional structure; or
a microelectromechanical system (MEMS) component configured to provide a mechanical signal to deform a structure of the one of the first functional structure or the second functional structure.

14. The device of claim 9, comprising a third functional structure having a third functionality, the third functional structure optically connected with the first functional structure in series or in parallel.

15. The device of claim 9, comprising a third functional structure having a third functionality, the third functional structure vertically disposed relative to the first functional structure.

16. A method of manufacturing a photonic integrated circuit, the method comprising:
providing a substrate;
forming a first waveguide and a second waveguide above the substrate; and
forming a functional structure adjacent to the second waveguide and optically connected with the second waveguide, the functional structure doped with a dopant that allows the functional structure to have a functionality, by one of:
depositing a functional material on the second waveguide and implanting the dopant into the functional material, or
transferring the functional structure doped with the dopant onto the second waveguide;
wherein a surface of the functional structure is configured to receive a signal configured to activate the functionality.

17. The method of claim 16,
wherein the functionality comprises, in response to receiving light, i) amplifying the light or ii) tuning a characteristic of the light, the characteristic including one of an amplitude, a phase, a wavelength, a spectral property, or a dispersion property of the light; and
wherein the dopant includes one of erbium, thulium, or ytterbium.

18. The method of claim 16, further comprising forming a second functional structure optically connected with the first waveguide, the second functional structure having a second functionality.

19. The method of claim 18, further comprising optically connecting a third functional structure with the first functional structure in series or in parallel, the third functional structure having a third functionality.

20. The method of claim 16, wherein the forming of the functional structure is performed by transferring the functional structure doped with the dopant onto the second waveguide, and includes:
bonding a surface of the functional structure with a surface of the second waveguide; and
annealing the bonded surfaces.
